(19) United States
(12) Patent Application Publication
(10) Pub. No.: US 2023/0164276 A1
(43) Pub. Date: May 25, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Hiroyuki TAKAYAMA, Kanagawa (JP)

(73) Assignee: FUJIFILM Business Innovation Corp., Tokyo (JP)

(21) Appl. No.: 17/743,461

(22) Filed: May 13, 2022

(30) Foreign Application Priority Data
Nov. 22, 2021 (JP) 2021-189730

(51) Int. Cl. H04N 1/00; H04N 1/387; H04N 1/32

(52) U.S. Cl. CPC H04N 1/00376; H04N 1/387; H04N 1/32101; H04N 2201/3271

(57) ABSTRACT

An information processing apparatus includes a processor configured to receive designation of a person capable of stamping on plural stamping areas in a document having the plural stamping areas, and present a stamping area that is capable of being stamped by a printer who performs printing to the printer as a different state from states of other stamping areas in a case where the document is printed and a condition is satisfied, in which the printer is a person capable of stamping on at least one of the plural stamping areas and a corresponding stamping area is before a stamping work by another person capable of stamping, and not present the stamping area in a case where the condition is not satisfied.

### CROSS-REFERENCE TO RELATED APPLICATIONS

This application is based on and claims priority under 35 USC 119 from Japanese Patent Application No. 2021-189730 filed Nov. 22, 2021.

### BACKGROUND

### (i) Technical Field

The present invention relates to an information processing apparatus, a non-transitory computer readable medium storing an information processing program, and an information processing method.

### (ii) Related Art

JP2019-164805A discloses a file management system including an image processing apparatus and a management apparatus for managing files, for the purpose of providing a structure for streamlining file updates by a plurality of people.

In the file management system, the image processing apparatus includes file selection means for selecting a first file to be edited, and user selection means for selecting a plurality of users who edit the first file. Further, in the file management system, the image processing apparatus includes designation means for designating a position in the first file to be edited by the selected user, and checkout instruction means for receiving a checkout instruction in order to edit the first file by the selected user. Further, in the file management system, the image processing apparatus includes transmission control means for transmitting a checkout request including file identification information of the first file, the plurality of users, and positional information in the first file.

Further, in the file management system, the management apparatus includes reception control means for receiving the checkout request including the file identification information of the first file, the plurality of users, and the positional information in the first file. Further, in the file management system, the management apparatus includes generation means for generating a plurality of second files from the first file corresponding to the file identification information according to the positional information. Then, in the file management system, the management apparatus includes checkout means for checking out the plurality of generated second files by using the plurality of users.

On the other hand, at present, there is an electronic contract service that enables electronic signatures such as DocuSign (registered trademark) and cloud sign (registered trademark), so that it is also possible to coexist the electronic contract approval flow and the paper contract approval flow.

### SUMMARY

In a case where the technology disclosed in JP2019-164805A is applied to a technology of the electronic contract service, the contract can be edited efficiently, but stamping conflicts may occur for an identical stamping area by a plurality of people. This problem is not limited to contracts, and may occur in all documents that require stamping for approval of instruction manuals, specifications, design materials, and the like.

Aspects of non-limiting embodiments of the present disclosure relate to an information processing apparatus, a non-transitory computer readable medium storing an information processing program, and an information processing method that are capable of avoiding the stamping conflicts for the stamping area by a plurality of the people.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive designation of a person capable of stamping on a plurality of stamping areas in a document having the plurality of stamping areas, and present a stamping area that is capable of being stamped by a printer who performs printing to the printer as a different state from states of other stamping areas in a case where the document is printed and a condition is satisfied, in which the printer is a person capable of stamping on at least one of the plurality of stamping areas and a corresponding stamping area is before a stamping work by another person capable of stamping, and not present the stamping area in a case where the condition is not satisfied.

### BRIEF DESCRIPTION OF THE DRAWINGS

Exemplary embodiment(s) of the present invention will be described in detail based on the following figures, wherein:

FIG. 1 is a block diagram showing an example of a configuration of an information processing system according to an exemplary embodiment;

FIG. 2 is a block diagram showing an example of a hardware configuration of an information processing apparatus according to the exemplary embodiment;

FIG. 3 is a block diagram showing an example of a functional configuration of the information processing apparatus according to the exemplary embodiment;

FIG. 4 is a schematic diagram showing an example of a configuration of a document information database according to the exemplary embodiment;

FIG. 5 is a front view showing an example of a document to be stamped according to the exemplary embodiment;

FIG. 6 is a schematic diagram showing an example of a configuration of an area information database according to the exemplary embodiment;

FIG. 7 is a flowchart showing an example of an assignment process according to the exemplary embodiment;

FIG. 8 is a front view showing an example of an initial information input screen according to the exemplary embodiment;

FIG. 9 is a front view showing an example of an assignment information input screen according to the exemplary embodiment;

FIG. 10 is a front view showing an example of the assignment information input screen according to the exemplary embodiment;

FIG. 11 is a schematic diagram showing an example of transition of the area information database according to the exemplary embodiment;

FIG. 12 is a flowchart showing an example of a print-compatible process according to the exemplary embodiment;

FIG. 13 is a front view showing an example of a print-free presentation screen according to the exemplary embodiment;

FIG. 14 is a front view showing an example of a stamp-free presentation screen according to the exemplary embodiment;

FIG. 15 is a front view showing an example of a print confirmation screen according to the exemplary embodiment;

FIG. 16 is a front view showing an example of guide information according to the exemplary embodiment;

FIG. 17 is a schematic diagram showing an example of a transition of an area information database according to the exemplary embodiment;

FIG. 18 is a flowchart showing an example of a stamping interruption process according to the exemplary embodiment;

FIG. 19 is a front view showing an example of a proxy stamping request screen according to the exemplary embodiment;

FIG. 20 is a front view showing an example of a continuation instruction screen according to the exemplary embodiment;

FIG. 21 is a flowchart showing an example of a merge process according to the exemplary embodiment; and

FIG. 22 is a front view showing an example of a document to be stamped after the stamped images according to the exemplary embodiment are merged.

### DETAILED DESCRIPTION

Hereinafter, an exemplary embodiment of the invention will be described in detail with reference to the drawings. In the present exemplary embodiment, a case where a contract is applied as a document relating to the exemplary embodiment of the invention and the exemplary embodiment of the invention is applied to a mode in which the contract content in the contract is approved and a stamping area of the contract is stamped will be described. However, the present exemplary embodiment is not limited thereto. For example, an exemplary embodiment may be provided in which another document that requires to stamp a seal for approval of an instruction manual, a specification, a design material, or the like is applied as the document of the exemplary embodiment of the invention.

In addition, a “stamping work” in the exemplary embodiment of the invention includes a work leading to the stamping in addition to a work of performing the stamping. For example, in the present exemplary embodiment, since the contract is applied as a document, a confirmation work of contract text described in the contract is also included in the stamping work. Further, for example, in a case where an instruction manual or the like is applied as the document, an editing work for the instruction manual or the like is also included in the stamping work.

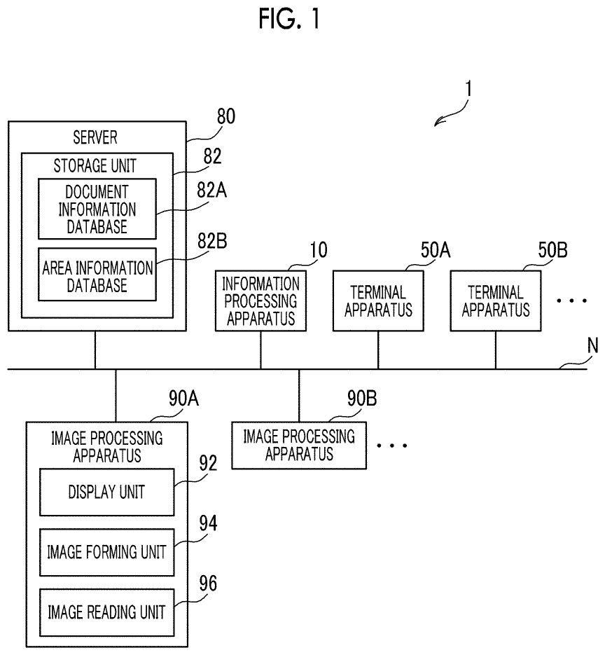

First, a configuration of an information processing system 1 according to the present exemplary embodiment will be described with reference to FIG. 1. FIG. 1 is a block diagram showing an example of the configuration of the information processing system 1 according to the present exemplary embodiment.

As shown in FIG. 1, the information processing system 1 according to the present exemplary embodiment includes an information processing apparatus 10, a plurality of terminal apparatuses 50A, 50B, . . . , a server 80, and a plurality of image processing apparatuses 90A, 90B, . . . In the following, in a case where the terminal apparatuses 50A, 50B, . . . are described without distinction, the terminal apparatuses are simply collectively referred to as a “terminal apparatus 50”. Further, in the following, in a case where the image processing apparatuses 90A, 90B, . . . are described without distinction, the image processing apparatuses are simply collectively referred to as an “image processing apparatus 90”.

Examples of the information processing apparatus 10, the terminal apparatus 50, and the server 80 include various computers such as a personal computer and a server computer. Further, in the present exemplary embodiment, as the image processing apparatus 90, a digital multifunction device having an image printing function, an image reading function, an image transmission function, and the like is applied. However, the exemplary embodiment of the invention is not limited thereto, and another image processing apparatus, such as an image processing apparatus having only the image printing function and the image reading function, may be applied as the image processing apparatus 90.

Further, not all of the image processing apparatuses 90A, 90B, . . . have identical specifications. The executable service may be different, the items that can be set for the service may be different, and the installed options may be different.

The information processing apparatus 10, the terminal apparatus 50, the server 80, and the image processing apparatus 90 are connected to each other via a network N, and the information processing apparatus 10 and the terminal apparatus 50 can communicate with the server 80 and each image processing apparatus 90 via the network N. In the present exemplary embodiment, a public communication line, such as the Internet or a telephone line network, is applied as the network N, but the network N is not limited to the present exemplary embodiment. For example, as the network N, a communication line in a company, such as a Local Area Network (LAN) or a Wide Area Network (WAN) may be applied, and a combination of the communication line in the company and the public communication line may be applied. Further, in the present exemplary embodiment, a wired communication line is applied as the network N, but the invention is not limited to the exemplary embodiment. A wireless communication line may be applied, and a combination of each of the wired and wireless communication lines may be applied.

As shown in FIG. 1, the server 80 according to the present exemplary embodiment includes a storage unit 82, and the storage unit 82 stores a document information database 82A and an area information database 82B. The storage unit 82 is realized by a Hard Disk Drive (HDD), a Solid State Drive (SSD), a flash memory, or the like. The details of the document information database 82A and the area information database 82B will be described later.

Further, the image processing apparatus 90 according to the present exemplary embodiment includes a display unit 92, an image forming unit 94, and an image reading unit 96. The image processing apparatus 90 can display various information by the display unit 92, can print various documents by the image forming unit 94, and can read images of the various documents by the image reading unit 96.

By the way, as described above, the information processing system 1 according to the present exemplary embodiment is applied to a work of approving the contract content in the contract and performing stamping in the stamping area of the contract. The information processing apparatus 10 according to the present exemplary embodiment is used by a person (hereinafter, referred to as a “determiner”) who determines a person (hereinafter, referred to as a “person capable of stamping”) who can perform stamping for each of the stamping areas provided in various contracts. Further, the terminal apparatus 50 according to the present exemplary embodiment is used by a predetermined person capable of stamping.

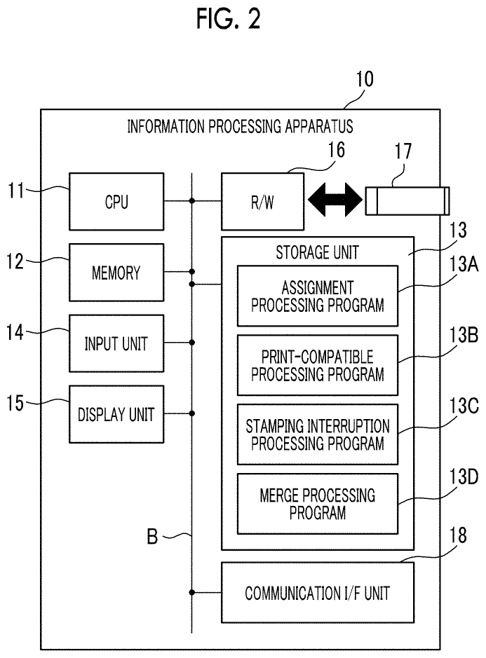

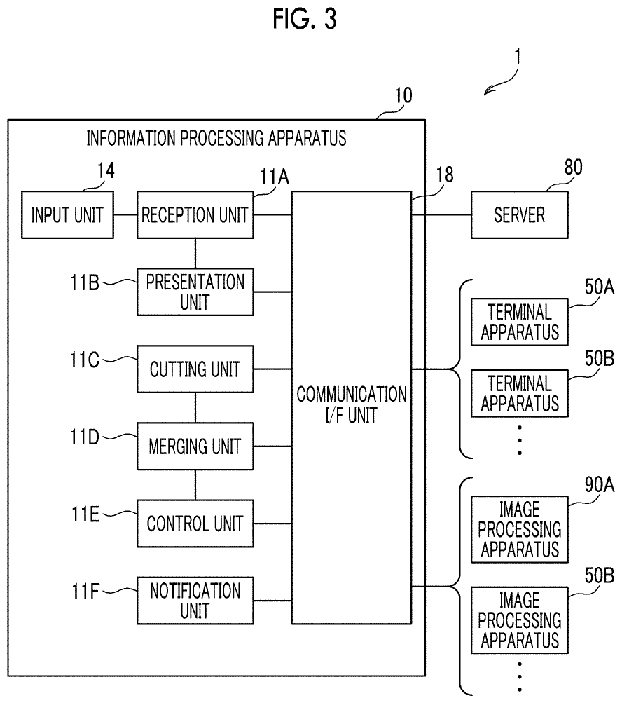

Next, a configuration of the information processing apparatus 10 according to the present exemplary embodiment will be described with reference to FIGS. 2 and 3. FIG. 2 is a block diagram showing an example of a hardware configuration of the information processing apparatus 10 according to the present exemplary embodiment, and FIG. 3 is a block diagram showing an example of a functional configuration of the information processing apparatus 10 according to the present exemplary embodiment.

As shown in FIG. 2, the information processing apparatus 10 according to the present exemplary embodiment has a Central Processing Unit (CPU) 11 as a processor, a memory 12 as a temporary storage area, a non-volatile storage unit 13, an input unit 14 such as a keyboard, a display unit 15 such as a liquid crystal display, a medium reading/writing device (R/W) 16, and a communication interface (I/F) unit 18. The CPU 11, the memory 12, the storage unit 13, the input unit 14, the display unit 15, the medium reading/writing device 16, and the communication I/F unit 18 are connected to each other via a bus B. The medium reading/writing device 16 scans information written in the recording medium 17 and writes information in the recording medium 17.

The storage unit 13 according to the present exemplary embodiment is realized by an HDD, an SSD, a flash memory, or the like. The storage unit 13 as a storage medium stores an assignment processing program 13A, a print-compatible processing program 13B, a stamping interruption processing program 13C, and a merge processing program 13D.

Each of the programs is stored (installed) in the storage unit 13 in such a way that the recording medium 17 in which each program is written is connected to the medium reading/writing device 16 and the medium reading/writing device 16 scans each of the programs from the recording medium 17. The CPU 11 appropriately scans the programs from the storage unit 13 and expands the programs in the memory 12, and sequentially executes the processes possessed by the programs.

Next, the functional configuration of the information processing apparatus 10 according to the present exemplary embodiment will be described with reference to FIG. 3. As shown in FIG. 3, the information processing apparatus 10 includes a reception unit 11A, a presentation unit 11B, a cutting unit 11C, a merging unit 11D, a control unit 11E, and a notification unit 11F. In a case where the CPU 11 of the information processing apparatus 10 executes each of the programs, the information processing apparatus 10 functions as the reception unit 11A, the presentation unit 11B, the cutting unit 11C, the merging unit 11D, the control unit 11E, and the notification unit 11F.

The reception unit 11A according to the present exemplary embodiment receives designation of a person capable of stamping on a plurality of stamping areas in a document (in the present exemplary embodiment, a contract and, hereinafter, referred to as “a document to be stamped”) having the plurality of stamping areas. Further, in a case where the document to be stamped is printed, the presentation unit 11B according to the present exemplary embodiment determines whether or not a condition (hereinafter, referred to as a “stampable condition”), in which a printer who performs the printing is a person capable of stamping on at least one of the plurality of stamping areas, that is, a corresponding stamping area is obtained before a stamping work by another person capable of stamping is performed, is satisfied. Then, the presentation unit 11B according to the present exemplary embodiment presents the stamping area that is capable of being stamped by the printer to the printer as a different state from states of other stamping areas in a case where the stampable condition is satisfied, and does present the stamping area in a case where the stampable condition is not satisfied. In the information processing system 1 according to the present exemplary embodiment, the printing of the document to be stamped is performed by any image processing apparatus 90 using the image forming unit 94 in response to an instruction from the terminal apparatus 50.

In particular, in the present exemplary embodiment, as the above-described different state, a state is applied in which the stamping area that is capable of being stamped by the printer is presented by being emphasized in comparison with the other stamping areas, but the exemplary embodiment of the invention is not limited thereto. For example, information indicating that the stamping is not possible (for example, x mark, - (hyphen), or the like) in the stamping area where the printer cannot perform stamping may be provided.

Further, in a case where the stampable condition is not satisfied, the presentation unit 11B according to the present exemplary embodiment provides both information indicating a situation related to the stampable condition and information indicating that a process for stamping is unnecessary to the printer. However, the exemplary embodiment of the invention is not limited thereto, and, in a case where the stampable condition is not satisfied, the presentation unit 11B provides either the information indicating a situation related to the stampable condition and the information indicating that a process for stamping is unnecessary to the printer.

In addition, in a case where the document to be stamped, which is stamped by the printer, is read and stamped document information, which indicates the document to be stamped, is obtained, the cutting unit 11C according to the present exemplary embodiment cuts the image only for the stamping area stamped by the printer. Then, the merging unit 11D according to the present exemplary embodiment merges the cut image into the corresponding area of the document information indicating the document to be stamped. In the information processing system 1 according to the present exemplary embodiment, the document to be stamped is read by any image processing apparatus 90 using the image reading unit 96.

Further, after performing the above-described merging, the control unit 11E according to the present exemplary embodiment performs control to store information indicating that the stamping area to be merged has been subjected to the stamping work. In the present exemplary embodiment, the case where the control unit 11E causes the storage unit 82 of the server 80 to store the information indicating that the stamping area has been subjected to the stamping work has been described, but the exemplary embodiment of the invention is not limited thereto. For example, the storage unit 13 of the information processing apparatus 10 may store information indicating that the stamping area has been subjected to the stamping work.

Further, in a case where the stamping work by the printer is stopped or interrupted, the notification unit 11F according to the present exemplary embodiment notifies of instruction information indicating that the other person capable of stamping on the corresponding stamping area is instructed to perform the stamping work corresponding to the stamping area.

By the way, unlike the case where the stamping work is stopped, a case where the stamping work is interrupted is often temporal takeaway from a seat such as participation in meetings, breaks, or the like. Therefore, in a case where the stamping work by the printer is interrupted, the notification unit 11F according to the present exemplary embodiment notifies the instruction information in a case where a predetermined period (15 minutes in the present exemplary embodiment) has elapsed.

Further, in a case where the stamping work by the printer is stopped or interrupted and in a case where there is no other person capable of stamping on the corresponding stamping area, the notification unit 11F according to the present exemplary embodiment notifies information indicating both a fact that the stamping work on the stamping area is continued and a fact that the other person capable of stamping is not capable of taking over the stamping work. However, the exemplary embodiment of the invention is not limited thereto, and only one of the fact that the stamping work on the stamping area is continued and the fact that the other person capable of stamping is not capable of taking over the stamping work may be presented.

On the other hand, in a case where the printer tries to print the document to be stamped again, that is, in a case where the stamping work is being performed on the document by the printer, the presentation unit 11B according to the present exemplary embodiment presents information indicating that the printing has already been performed to the printer.

Further, the notification unit 11F according to the present exemplary embodiment notifies that stamping on the corresponding stamping area is possible to the person for whom the designation is received by the reception unit 11A.

In the present exemplary embodiment, the case where various information is notified by the notification unit 11F via the network N has been described, but the exemplary embodiment of the invention is not limited thereto. For example, while the information processing apparatus 10 is provided with a wireless communication unit, the terminal apparatus 50, the server 80, and the image processing apparatus 90 may be also provided with a wireless communication unit capable of performing wireless communication with the wireless communication unit so that the various information may be notified by the notification unit 11F through the wireless communication.

Further, in the present exemplary embodiment, the presentation by printing by the image processing apparatus 90 is applied as the presentation of the stampable area by the presentation unit 11B, but the exemplary embodiment of the invention is not limited thereto. For example, in addition to the presentation by printing, at least one of the presentation by display by the display unit of the terminal apparatus 50, the display unit 92 of the image processing apparatus 90, or the like, and the presentation by voice by a speaker or the like provided in the terminal apparatus 50 may be applied as the presentation of the stampable area.

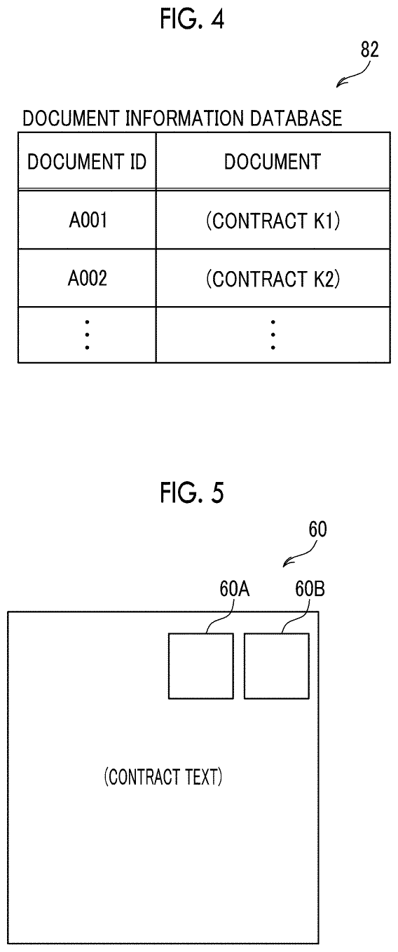

Next, the document information database 82A according to the present exemplary embodiment will be described with reference to FIG. 4. FIG. 4 is a schematic diagram showing an example of a configuration of the document information database 82A according to the present exemplary embodiment.

The document information database 82A according to the present exemplary embodiment is a database in which information related to the above-described document to be stamped is registered, and, as an example, a document ID

(Identification) and each information of the document are associated with each other and stored, as shown in FIG. 4.

The document ID is information given in advance as different for each of the documents to be stamped in order to individually specify the corresponding document to be stamped. Further, the document is information indicating the corresponding document to be stamped.

Here, the document to be stamped 60 according to the present exemplary embodiment will be described with reference to FIG. 5. FIG. 5 is a front view showing an example of the document to be stamped 60 according to the present exemplary embodiment.

As shown in FIG. 5, the document to be stamped 60 according to the present exemplary embodiment has an area written with contract text which is a sentence expressing contract content, and has two stamping areas 60A and 60B in a part of the area.

In the present exemplary embodiment, the upper end of the document to be stamped, that is, an area of the right end is applied as the position where the stamping area is provided, but the exemplary embodiment of the invention is not limited thereto. As long as inside the document to be stamped, any position may be the position where the stamping area is provided. Further, FIG. 5 illustrates the document to be stamped 60 provided with two stamping areas as the document to be stamped, but the exemplary embodiment of the invention is not limited thereto. A document to be stamped, which is provided with three or more stamping areas, may be applied as the document to be stamped.

In the document information database 82A according to the present exemplary embodiment, as the information indicating the document, the information indicating the document to be stamped, which indicates the contract as described above, is stored. In the following, a case where the document to be stamped, to which “A001” is given as the document ID, is made as the document to be stamped 60 shown in FIG. 5 will be described.

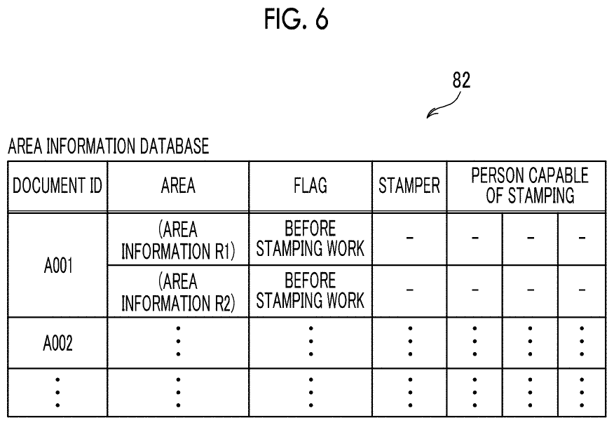

Next, the area information database 82B according to the present exemplary embodiment will be described with reference to FIG. 6. FIG. 6 is a schematic diagram showing an example of a configuration of the area information database 82B according to the present exemplary embodiment.

The area information database 82B according to the present exemplary embodiment is a database in which information related to each stamping area of the document to be stamped, which will be applied in the information processing system 1, is registered, and as an example, as shown in FIG. 6, each information on the document ID, the area, the flag, the stamper, and the person capable of stamping is associated and stored.

The document ID is identical information as the document ID of the document information database 82A, and the area is information indicating a position of the stamping area provided in the corresponding document to be stamped. In the present exemplary embodiment, as the information indicating the position of the stamping area, a two-dimensional coordinate position, in which a predetermined position of the corresponding document to be stamped (in the present exemplary embodiment, a position of an upper left corner) is used as the origin, is applied. However, needless to say, the present exemplary embodiment is not limited thereto. Further, in the present exemplary embodiment, the case where the shape (rectangle in the present exemplary embodiment) and the size of the stamping area are predetermined and the central position of the corresponding stamping area is applied as the two-dimensional coordinate position has been described. However, needless to say, the present exemplary embodiment is not limited thereto.

On the other hand, the flag is information indicating a situation of the stamping work for the corresponding stamping area. In the present exemplary embodiment, any one information is selectively stored among three types of information including “before stamping work”, “in the middle of stamping work”, and “completion of stamping work”. In the example shown in FIG. 6, “before stamping work” is registered as the default information indicating the above flag for all the stamping areas in all the documents to be stamped.

Further, the stamper is information indicating a person who is in the middle of stamping work or has completed the stamping work for the corresponding stamping area, and the person capable of stamping is information indicating a person having an authority to stamp the corresponding stamping area. In the example shown in FIG. 6, “-” is stored as default information indicating each of the stamper and the person capable of stamping on all the stamping areas in all the documents to be stamped.

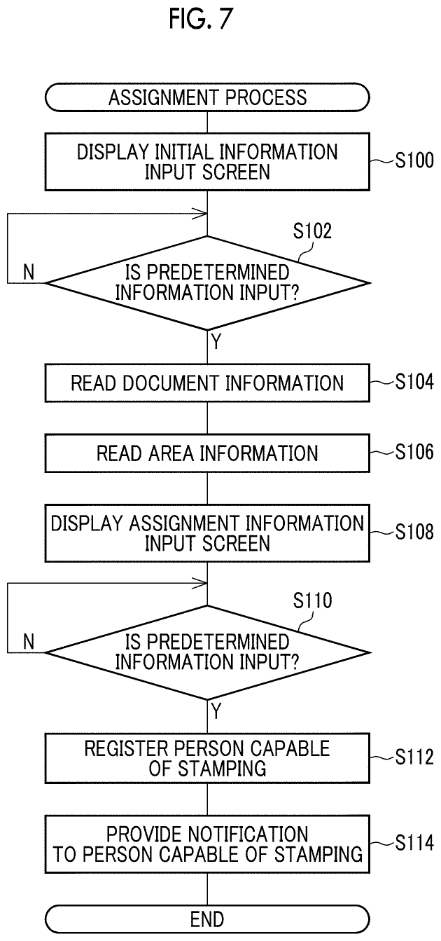

Next, with reference to FIGS. 7 to 22, an operation of the information processing apparatus 10 that plays a central role in the information processing system 1 will be described as an operation of the information processing system 1 according to the present exemplary embodiment.

First, with reference to FIGS. 7 to 11, the operation in a case where the assignment process is executed in the information processing apparatus 10 according to the present exemplary embodiment will be described. As described above, in the information processing system 1 according to the present exemplary embodiment, the above-described determiner determines a person who has the authority to stamp on the stamping area of the document to be stamped. The assignment process is a process executed in a case where the determiner determines a person capable of stamping, and in a case where the determiner inputs an instruction instructing the start of execution of the assignment process, the CPU 11 of the information processing apparatus 10 is executed by executing the assignment processing program 13A. FIG. 7 is a flowchart showing an example of the assignment process according to the present exemplary embodiment. Here, in order to avoid confusion, a case where the document information database 82A has already been subjected to construction and the area information database 82B has been constructed in a default state will be described.

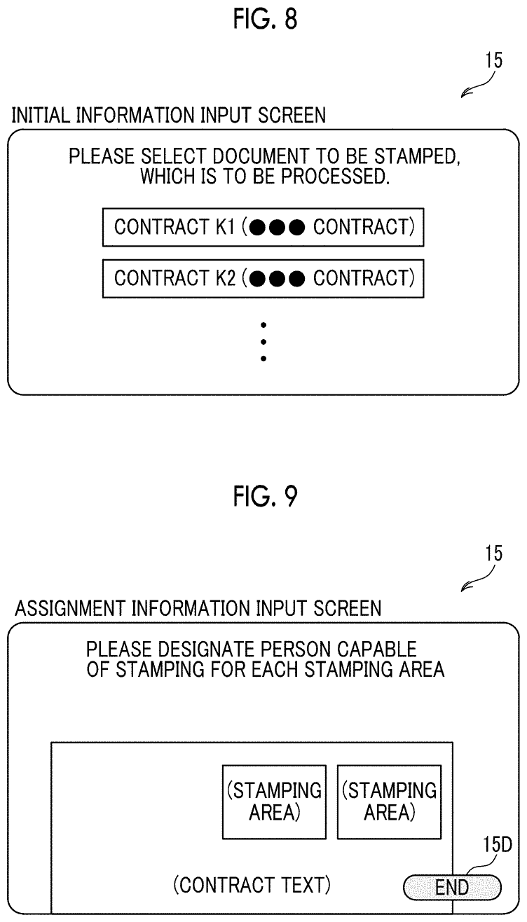

In step S100 of FIG. 7, the CPU 11 controls the display unit 15 so as to display an initial information input screen having a predetermined configuration. In step S102, the CPU 11 waits until the predetermined information is input. FIG. 8 shows an example of the initial information input screen according to the present exemplary embodiment.

As shown in FIG. 8, on the initial information input screen according to the present exemplary embodiment, a message prompting selection of the document to be stamped, which will be processed, is displayed. Further, on the initial information input screen according to the present exemplary embodiment, the information representing the document to be stamped, which is registered in the document information database 82A, is displayed in a state that can be selected by the determiner.

In a case where the initial information input screen shown in FIG. 8 is displayed on the display unit 15, the determiner designates a display area of information indicating the document to be stamped, which will be processed, via the input unit 14. In a case where the display area is designated by the determiner, a positive determination is made in step S102 and the process proceeds to step S104.

In step S104, the CPU 11 scans information (hereinafter, referred to as “processing document information”) indicating the document to be stamped, which is designated by the determiner (hereinafter, referred to as “document to be processed”) from the document information database 82A. In step S106, the CPU 11 scans information indicating an area corresponding to the document to be processed (hereinafter, referred to as “processing area information”) from the area information database 82B.

In step S108, the CPU 11 controls the display unit 15 so as to display the assignment information input screen having a predetermined configuration by using the scan processing document information and processing area information. In step S110, the CPU 11 waits until the predetermined information is input. FIG. 9 shows an example of the assignment information input screen according to the present exemplary embodiment.

As shown in FIG. 9, on the assignment information input screen according to the present exemplary embodiment, a message prompting the designation of the person capable of stamping on each stamping area is displayed. Further, on the assignment information input screen according to the present exemplary embodiment, the document to be processed indicated by the scan processing document information is displayed in a state in which each of the stamping areas can be designated.

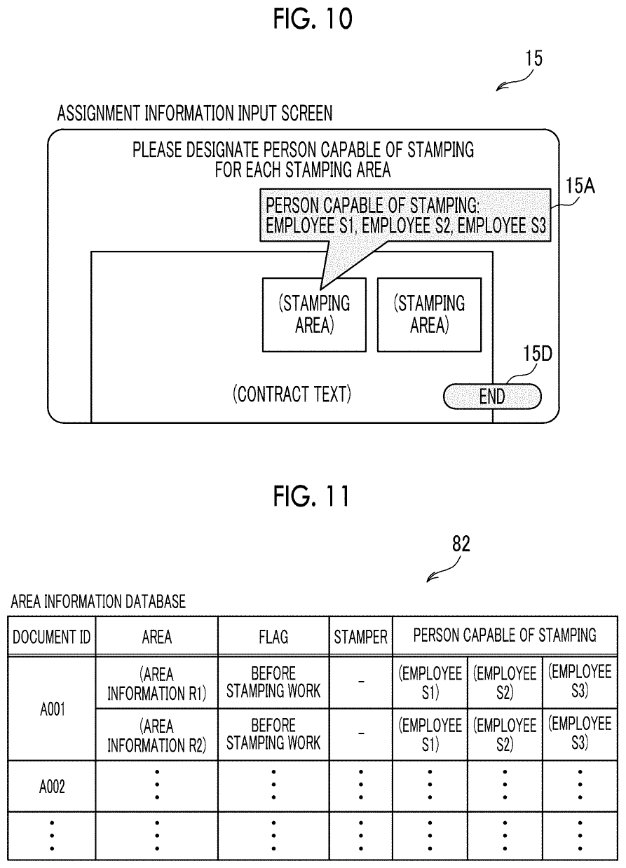

In a case where the assignment information input screen shown in FIG. 9 is displayed on the display unit 15, the determiner designates the stamping area to be designated by the person capable of stamping via the input unit 14. In response to the designation of the stamping area, as an example, the CPU 11 displays a balloon 15A having the stamping area as a balloon source in a state in which a person capable of stamping on the stamping area can be input, as shown in FIG. 10.

Therefore, the determiner inputs the person capable of stamping into the displayed balloon 15A via the input unit 14 for all the intended stamping areas. Then, the determiner designates an end button 15D via the input unit 14 in a case where the input of the corresponding person capable of stamping is completed for all the intended stamping areas. In a case where the end button 15D is designated by the determiner, a positive determination is made in step S110 and the process proceeds to step S112. FIG. 10 illustrates a state in which the stamping area on the left side is designated by the determiner and three people, that is, an employee S1, an employee S2, and an employee S3 are input as the person capable of stamping to the balloon 15A corresponding to the stamping area.

In step S112, the CPU 11 stores (registers) the person who is capable of stamping and input by the determiner on the assignment information input screen in the storage area of the corresponding person capable of stamping in the area information database 82B. In step S114, the CPU 11 notifies that the corresponding stamping area can be stamped to all the people who are capable of stamping and input by the determiner, and, thereafter, ends the present assignment process. In the present exemplary embodiment, the notification is directly provided to the terminal apparatus 50 used by the person capable of stamping by e-mail via the network N, but the exemplary embodiment of the invention is not limited thereto. For example, the notification may be indirectly performed via the server 80, or the notification may be performed using a tool other than e-mail, such as a messaging service such as +message (registered trademark) or LINE (registered trademark).

FIG. 11 shows a schematic diagram showing an example of the transition of the area information database 82B according to the present exemplary embodiment. As an example, as shown in FIG. 11, by the above assignment process, in the storage area for the person capable of stamping in the area information database 82B, information indicating the person capable of stamping is registered in each of the stamping areas provided in the document to be processed.

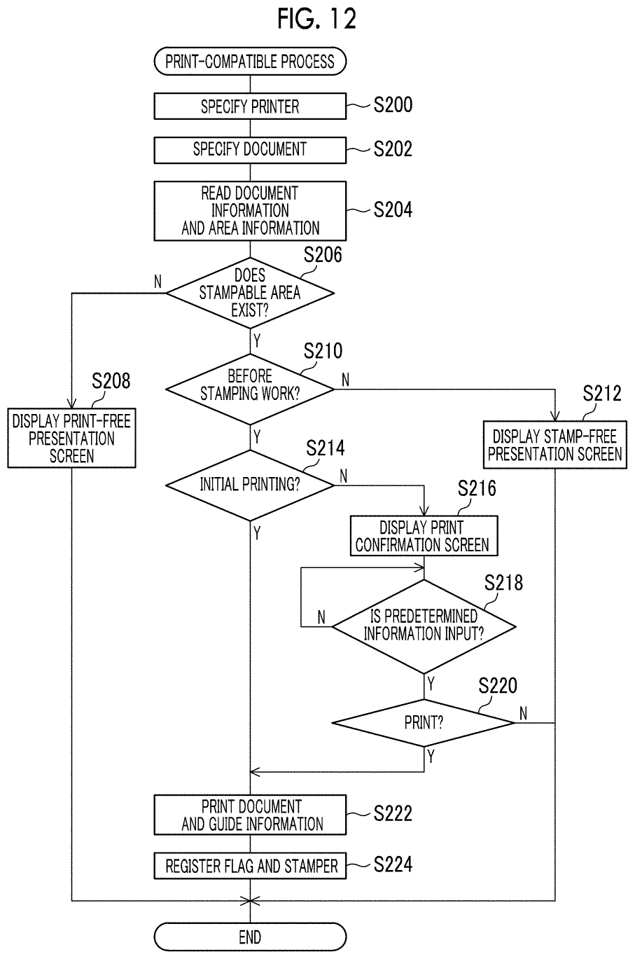

Next, with reference to FIGS. 12 to 17, the operation in a case where the print-compatible process is executed in the information processing apparatus 10 according to the present exemplary embodiment will be described. As described above, in the information processing system 1 according to the present exemplary embodiment, in a case where the document to be stamped is printed, various processes are executed according to the success or failure of the stampable condition. The print-compatible process is executed in such a way that the CPU 11 of the information processing apparatus 10 executes the print-compatible processing program 13B in a case where any terminal apparatus 50 instructs any image processing apparatus 90 to print the document to be stamped. FIG. 12 is a flowchart showing an example of the print-compatible process according to the present exemplary embodiment. Here, a case where the document information database 82A is constructed, and a case of a state in which the area information database 82B is shown in FIG. 11, that is, a state in which the person capable of stamping is registered will be described.

In step S200 of FIG. 12, the CPU 11 specifies a person (hereinafter, referred to as a “printer”) who has instructed to print the document to be stamped. The printer can be specified by specifying the terminal apparatus 50 (hereinafter, referred to as “print instruction terminal apparatus”) that has instructed to print the document to be stamped.

In step S202, the CPU 11 specifies the document to be stamped for which printing is instructed. The document to be stamped can be specified by specifying the document to be stamped, which is designated by the print instruction terminal apparatus in a case of instructing to print the document to be stamped.

In step S204, the CPU 11 scans information (hereinafter, referred to as “printing document information”) indicating the specified document to be stamped (hereinafter, referred to as “document to be printed”) from the document information database 82A.

Further, in step S204, the CPU 11 scans information indicating each of the area corresponding to the document to be printed, the flag, the stamper, and the person capable of stamping (hereinafter, referred to as “printing area information”) from the area information database 82B.

In step S206, the CPU 11 uses the scan printing area information to determine whether or not there is a stamping area, in which the specified printer is set as a person capable of stamping, in the stamping area provided in the document to be printed. In a case where a negative determination is made, the process proceeds to step S208.

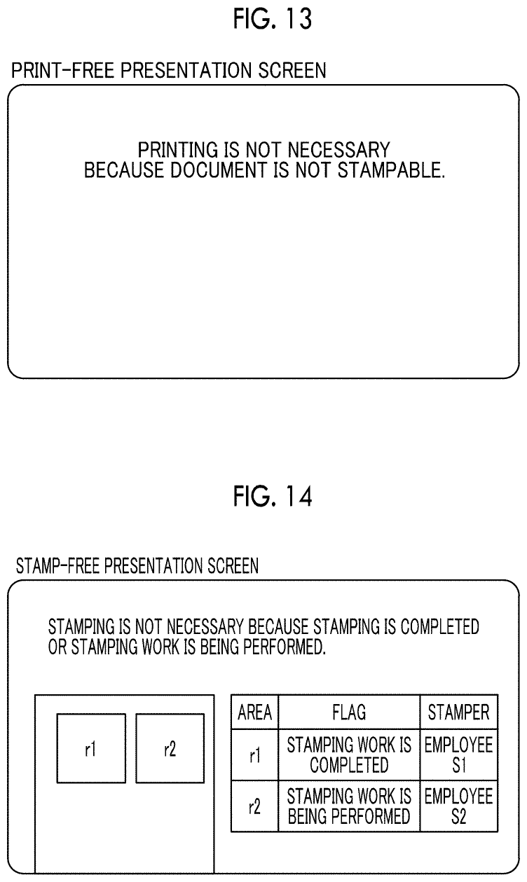

In step S208, the CPU 11 controls the print instruction terminal apparatus to display a print-free presentation screen having a predetermined configuration, and, thereafter, ends the present print-compatible process. FIG. 13 shows an example of the print-free presentation screen according to the present exemplary embodiment.

As shown in FIG. 13, the print-free presentation screen according to the present exemplary embodiment is displayed with a message indicating a fact that the document that cannot be not stamped and a fact that printing is unnecessary. Therefore, by referring to the print-free presentation screen, the printer can grasp that the document to be printed, by which the printer intends to print, is not a document that needs stamping by the printer and does not need printing.

On the other hand, in a case where a positive determination is made in step S206, the process proceeds to step S210. In step S210, the CPU 11 uses the printing area information to determine whether or not there is a stamping area in which the printer is set as a person capable of stamping and “before the stamping work” is registered as a flag in the stamping area provided on the document to be printed. In a case where a negative determination is made, the process proceeds to step S212.

In step S212, the CPU 11 uses the printing document information and the printing area information to control the print instruction terminal apparatus to display a stamp-free presentation screen having a predetermined configuration, and, thereafter, ends the print-compatible process. FIG. 14 shows an example of a stamp-free presentation screen according to the present exemplary embodiment.

As shown in FIG. 14, the stamp-free presentation screen according to the present exemplary embodiment is displayed with a message indicating a fact that the document to be printed has been subjected to the stamping work or the stamping work is being performed on the document to be printed and a fact that the stamping is not required is displayed. Therefore, the printer can grasp that the document to be printed, by which the printer intends to print, is not required to be stamped by the printer, and a reason thereof.

Further, the stamp-free presentation screen according to the present exemplary embodiment is displayed with each stamping area in the document to be printed as an image, and is displayed with information set as the flag in a state of being associated with the image (“completion of stamping work” or “in the middle of stamping work”)and the stamper. Therefore, the printer can grasp the stamper and a stamping situation for each stamping area of the document to be printed by referring to the stamp-free presentation screen.

On the other hand, in a case where a positive determination is made in step S210, the process proceeds to step S214. In step S214, the CPU 11 determines whether or not the printing of the current document to be printed is the first printing for the printer, and, in a case where a positive determination is made, the process proceeds to step S222 which will be described later. In a case where a negative determination is made in step S214, the process proceeds to step S216.

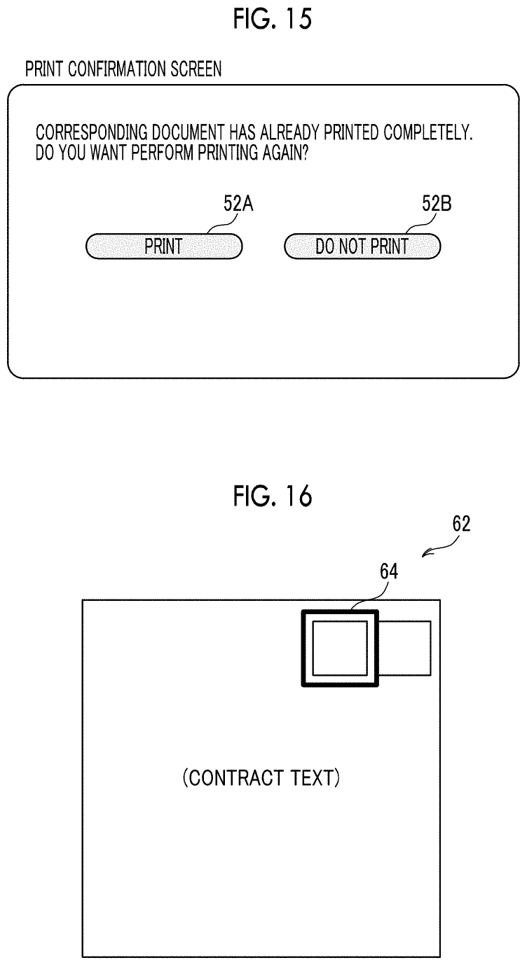

In step S216, the CPU 11 controls the print instruction terminal apparatus to display a print confirmation screen having a predetermined configuration. In step S218, the CPU 11 waits until the predetermined information is input. FIG. 15 shows an example of the print confirmation screen according to the present exemplary embodiment.

As shown in FIG. 15, the print confirmation screen according to the present exemplary embodiment is displayed with a message indicating that the document to be printed has already been printed and prompting an instruction input as to whether or not to print again. Therefore, the printer can grasp that the document to be printed, which is intended to be printed by the printer, has already been printed. Then, the printer designates a print button 52A in a case of printing the document to be printed again, and designates a non-print button 52B in a case of not printing. In response to the designation, a positive determination is made in step S218, and the process proceeds to step S220.

In step S220, the CPU 11 determines whether or not to print the document to be printed by determining whether or not the print button 52A is designated by the printer, and, in a case where a negative determination is made, ends the present print-compatible process by considering that the non-print button 52B is designated by the printer. On the other hand, in a case where a positive determination is made in step S220, the process proceeds to step S222.

In step S222, the CPU 11 uses the scan printing document information and the printing area information, and controls the image processing apparatus 90 which has instructed to print the document to be printed by the printer so as to print the document to be printed and guide information having a predetermined configuration. In response to the control, the image processing apparatus 90 prints the document to be printed and the guide information. FIG. 16 shows an example of guide information 62 according to the present exemplary embodiment.

As shown in FIG. 16, in the guide information 62 according to the present exemplary embodiment, the same information as the document to be printed is printed, but, for the stamping area in the document to be printed, the stamping area which can be stamped by the printer is printed in a different state from states of other stamping areas. In particular, in the guide information 62 according to the present exemplary embodiment, the stamping area that can be stamped by the printer is printed in a state of being emphasized in comparison with other stamping areas. Therefore, the printer can easily grasp a stamping area to be stamped by the printer by referring to the printed guide information 62.

In this case, there may be a plurality of stamping areas that can be stamped by the printer, but in the present exemplary embodiment, the contract is applied as the document, and the plurality of stamping areas are stamped by different people capable of stamping. Therefore, in the present exemplary embodiment, any one of stamping area in the plurality of stamping areas is selectively applied. In this case, an arbitrary one stamping area may be selected, but, in the present exemplary embodiment, the stamping area may be applied one by one from the left end side or the right end side according to the stamping order in chronological order for the contract in the related art.

Further, in the present exemplary embodiment, as an example, only the stamping area that can be stamped by the printer is surrounded by a thick line 64 to emphasize the stamping area, as shown in FIG. 16, but the exemplary embodiment of the invention is not limited thereto. For example, by printing only the stamping area that can be stamped by the printer in a different color or in a different size from colors or sizes of other stamping areas, the stamping area that can be stamped by the printer may be emphasized.

In step S224, the CPU 11 stores (registers), for the area information database 82B, the information of “in the middle of stamping work” as a flag corresponding to the stamping area that can be stamped by the printer, in the document to be printed, stores (registers) information indicating the printer as the stamper corresponding to the stamping area, and, thereafter, ends the print-compatible process.

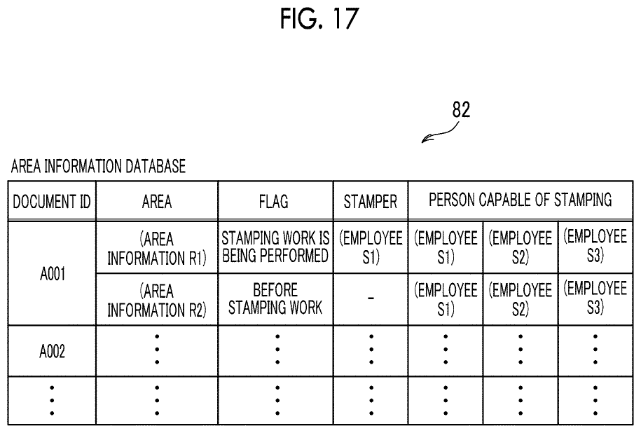

FIG. 17 shows a schematic diagram showing an example of the transition of the area information database 82B according to the present exemplary embodiment. As an example, as shown in FIG. 17, by the above print-compatible process, the area information database 82B is registered with a flag corresponding to the stamping area in which the stamping work is performed by the printer in the stamping area provided in the document to be printed, and each information of the stamper.

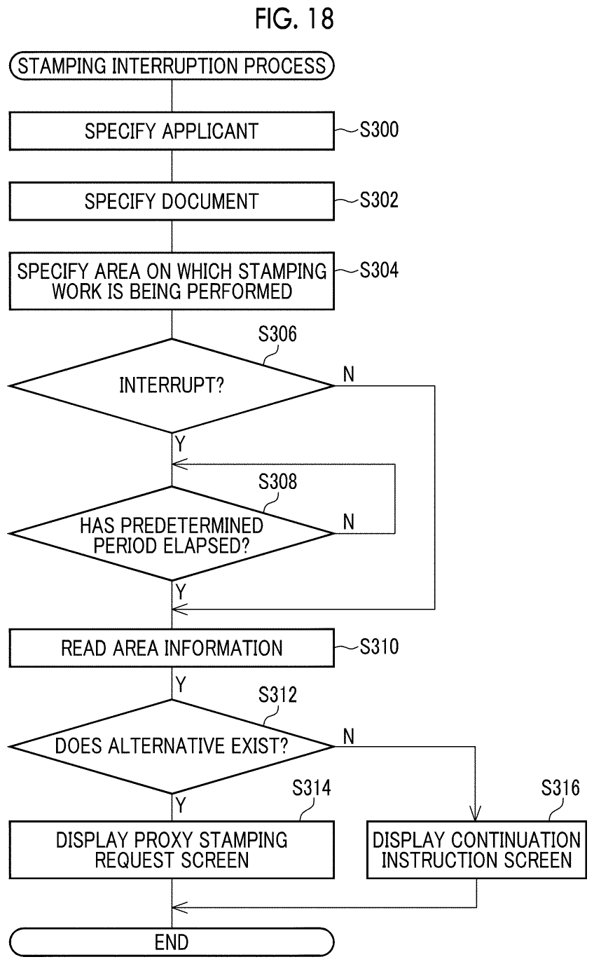

Next, with reference to FIGS. 18 to 20, an operation performed in a case where the stamping interruption process is executed in the information processing apparatus 10 according to the present exemplary embodiment will be described. As described above, in the information processing system 1 according to the present exemplary embodiment, in a case where the stamping work by the printer is stopped or interrupted, the other person capable of stamping on the stamping area is instructed to perform the stamping work corresponding to the stamping area. The stamping interruption process is executed in such a way that the CPU 11 of the information processing apparatus 10 executes the stamping interruption processing program 13C in a case where an application for stopping or interrupting the stamping work is made from any of the terminal apparatuses 50 used by the person capable of stamping. FIG. 18 is a flowchart showing an example of the stamping interruption process according to the present exemplary embodiment.

In step S300 of FIG. 18, the CPU 11 specifies a person capable of stamping (hereinafter, referred to as “applicant”) who has applied for stopping or interrupting the stamping work. The applicant can be specified by specifying the terminal apparatus 50 used for the application (hereinafter, referred to as “application terminal apparatus”).

In step S302, the CPU 11 specifies the document to be stamped for the stamping work for which stop or interruption has been applied. Immediately before the application is made, specification of the document to be stamped can be performed by specifying the document to be stamped, to which the printing instruction is given by the application terminal apparatus from the person who is capable of stamping and has made application.

In step S304, the CPU 11 specifies the stamping area (hereinafter, referred to as “stamping area to be applied”) for which the applicant has stopped or interrupted the stamping work. The specification of the stamping area to be applied corresponds to the document to be stamped, which is specified by the process of step S302, “in the middle of stamping work” is registered as the flag, and can be performed by searching the area information database 82B for information indicating the area of the stamping area which is registered by an applicant as the corresponding stamper.

In step S306, the CPU 11 determines whether or not the interruption has been applied for by the applicant, the process proceeds to step S310 in a case where a negative determination is made, and the process proceeds to step S308 in a case where a positive determination is made.

In step S308, the CPU 11 waits until a predetermined period (15 minutes in the present exemplary embodiment) has elapsed. In step S310, the CPU 11 scans information (hereinafter, referred to as “information on person capable of stamping”) corresponding to the document to be stamped, which is specified by the process of step S302, and corresponding to all the information indicating the person capable of stamping and corresponding to the stamping area to be applied, from the area information database 82B.

In step S312, the CPU 11 determines whether or not there is a person capable of stamping (hereinafter, referred to as “alternative”) other than the applicant in people who are capable of stamping and indicated by the scan information on person capable of stamping, and the process proceeds to step S314 in a case where a positive determination is made.

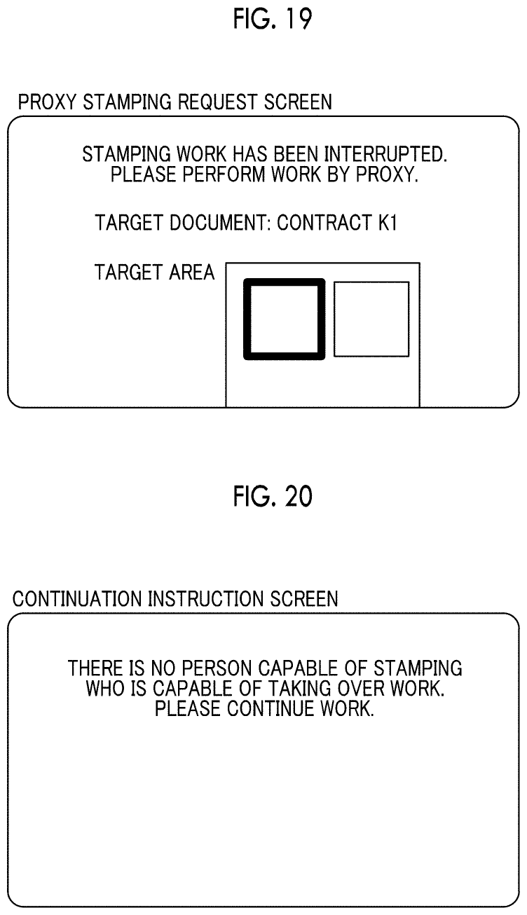

In step S314, the CPU 11 controls the terminal apparatus 50 used by the alternative to display a proxy stamping request screen (corresponding to the above-described instruction information) having a predetermined configuration, and ends the present stamping interruption process thereafter. FIG. 19 shows an example of the proxy stamping request screen according to the present exemplary embodiment.

As shown in FIG. 19, the proxy stamping request screen according to the present exemplary embodiment is displayed with a message indicating that the stamping work has been interrupted and instructing to perform the stamping work by proxy. Further, the proxy stamping request screen according to the present exemplary embodiment is displayed with information indicating the target document and information indicating the target stamping area. Therefore, the person (alternative) who is capable of stamping and has referred to the proxy stamping request screen can easily grasp that the stamping work needs to be performed by proxy and a target for which the stamping work is performed, thereby taking over the stamping work.

On the other hand, in a case where a negative determination is made in step S312, the process proceeds to step S316. The CPU 11 controls the application terminal apparatus to display a continuation instruction screen having a predetermined configuration, and, thereafter, end the present stamping interruption process. FIG. 20 shows an example of the continuation instruction screen according to the present exemplary embodiment.

As shown in FIG. 20, on the continuation instruction screen according to the present exemplary embodiment, a message is displayed which indicates that there is no person who can stamp on the stamping area to be applied and that continuation of the stamping work is instructed. Therefore, as a result that the applicant can grasp that the stamping work needs to be continued because there is no person who can stamp on a stamping area to be applied by proxy, the occurrence of a situation can be avoided that the stamping is never done for the stamping area to be applied.

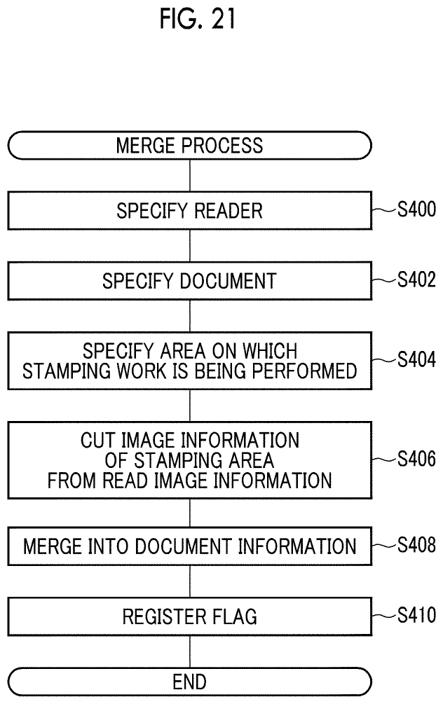

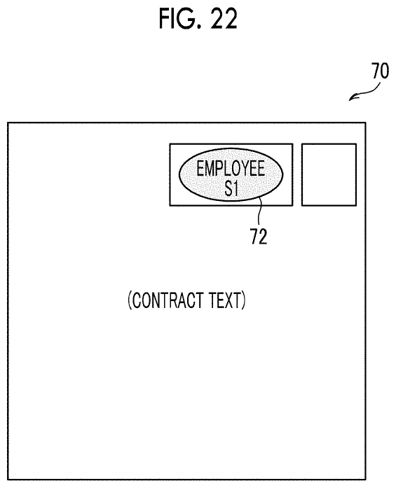

Next, an operation performed in a case where the merge process is executed in the information processing apparatus 10 according to the present exemplary embodiment will be described with reference to FIGS. 21 to 22. As described above, in the information processing system 1 according to the present exemplary embodiment, in a case where the document to be stamped, which is stamped by the printer, is read and the stamped document information is obtained, the image of the stamping area stamped by the printer is merged into a corresponding area of the document information indicating the document to be stamped. The merge process is executed in such a way that the CPU 11 of the information processing apparatus 10 executes the merge processing program 13D in a case where the document to be stamped is read by using the image reading unit 96 of any of the image processing apparatuses 90. FIG. 21 is a flowchart showing an example of the merge process according to the present exemplary embodiment.

In step S400 of FIG. 21, the CPU 11 specifies the person (hereinafter, referred to as “reader”) who is capable of stamping and has read the document to be stamped. The reader can be specified by specifying a person who is logged in to the image processing apparatus 90 that has read the document to be stamped at this time.

In step S402, the CPU 11 specifies the read document to be stamped (hereinafter, referred to as “document to be read”). The document to be read can be specified by searching the area information database 82B for a document in which “in the middle of stamping work” is registered as the flag and a reader is registered as the stamper.

In step S404, the CPU 11 specifies the stamping area stamped by the reader in the document to be read (hereinafter, referred to as “stamped stamping area”). The stamped stamping area can be specified by searching the area information database 82B for an area in which “in the middle of stamping work” is registered as the flag and a reader is registered as the stamper.

In step S406, the CPU 11 cuts the image information (hereinafter, referred to as “stamped image”) of the area corresponding to the specified stamped stamping area, from image information (corresponding to the above-described stamped document information) obtained by reading the document to be read. In step S408, the CPU 11 merges the cut stamped image into a corresponding position of information (hereinafter, referred to as “original document information”) indicating a document stored in the document information database 82A corresponding to the specified document to be read. In step S410, the CPU 11 stores (registers) information “stamping work is completed” as a flag corresponding to the stamped stamping area in the document to be read in the area information database 82B, and, thereafter, ends the merge process. In the present exemplary embodiment, overwrite storage is applied as the merge process, but the exemplary embodiment of the invention is not limited thereto. For example, a process of associating and storing the cut stamped image with the original document information may be applied as the merge process.

FIG. 22 shows an example of a document (hereinafter, referred to as “original document”) 70 indicated by the original document information obtained after the stamped images according to the present exemplary embodiment is merged. As shown in FIG. 22, by the above-described merge process, the original document 70 is in a state in which the stamped image 72, that is, the image showing the imprint by the stamping is superimposed.

In the above exemplary embodiment, the case where the document to be stamped is printed in such a way that the terminal apparatus 50 instructs to the image processing apparatus 90 to print the document to be stamped has been described, but the exemplary embodiment of the invention is not limited thereto. For example, the document to be stamped may be printed by directly instructing the image processing apparatus 90 to print the document to be stamped without using the terminal apparatus 50. In this case, the printer can be specified by using the information input by the login operation to the image processing apparatus 90.

Further, in the above exemplary embodiment, the case where the information processing apparatus 10 executes each of the assignment process, the print-compatible process, the stamping interruption process, and the merge process has been described, but the exemplary embodiment of the invention is not limited thereto. For example, the image processing apparatus 90 may execute each of the processes, or the server 80 may execute each of the e processes.

Further, in the above exemplary embodiment, the case where various databases are registered in the server 80 has been described, but the exemplary embodiment of the invention is not limited thereto. For example, various databases may be registered in the information processing apparatus 10, or various databases may be registered in another device accessible from the information processing apparatus 10 such as the image processing apparatus 90.

The exemplary embodiment has been described above, the technical scope of the exemplary embodiment of the invention is not limited to the scope described in the above embodiment. Various changes or improvements can be added to the above exemplary embodiment without departing from the gist of the invention, a form to which the changes and improvements are added is also included in the technical scope of the invention.

Further, the exemplary embodiment does not limit the invention according to the claims, and not all combinations of features described in the exemplary embodiment are necessary for the means for achieving the invention. The above-described exemplary embodiments include the invention at various stages, and various inventions are extracted by combining a plurality of disclosed components. Even in a case where some components are deleted from all the components shown in the exemplary embodiment, the configuration in which some of the components are deleted may be extracted as the invention as long as the effect is obtained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, in the above exemplary embodiment, the case where the information processing is realized with a software configuration using a computer by executing a program has been described, but the exemplary embodiment of the invention is not limited thereto. For example, information processing may be realized by a hardware configuration or a combination of the hardware configuration and the software configuration.

In addition, the configuration of the information processing apparatus 10 described in the exemplary embodiment is an example, and unnecessary parts may be deleted or new parts may be added within a range that does not deviate from the gist of the invention.

Further, the flow of each process described in the exemplary embodiment is also an example, and unnecessary steps may be deleted, new steps may be added, or processing order may be changed within the range that does not deviate from the gist of the invention.

What is claimed is:

1. An information processing apparatus comprising:
a processor configured to:
receive designation of a person capable of stamping on a plurality of stamping areas in a document having the plurality of stamping areas; and
present a stamping area that is capable of being stamped by a printer who performs printing to the printer as a different state from states of other stamping areas in a case where the document is printed and a condition is satisfied, in which the printer is a person capable of stamping on at least one of the plurality of stamping areas and a corresponding stamping area is before a stamping work by another person capable of stamping, and not present the stamping area in a case where the condition is not satisfied.

2. The information processing apparatus according to claim 1,
wherein the different state is a state in which the stamping area that is capable of being stamped by the printer is presented by being emphasized in comparison with the other stamping areas.

3. The information processing apparatus according to claim 2,
wherein the presentation is at least one of presentation by printing, presentation by display, or presentation by voice.

4. The information processing apparatus according to claim 1, wherein the processor is configured to:
resent at least one of information indicating a situation related to the condition or information indicating that a process for stamping is unnecessary to the printer, in a case where the condition is not satisfied.

5. The information processing apparatus according to claim 2, wherein the processor is configured to:
present at least one of information indicating a situation related to the condition or information indicating that a process for stamping is unnecessary to the printer, in a case where the condition is not satisfied.

6. The information processing apparatus according to claim 3, wherein the processor is configured to:
present at least one of information indicating a situation related to the condition or information indicating that a process for stamping is unnecessary to the printer, in a case where the condition is not satisfied.

7. The information processing apparatus according to claim 1, wherein the processor is configured to:
cut an image only for the stamping area stamped by the printer in a case where the document stamped by the printer is read and stamped document information, which indicates the read document, is obtained, and
merge the cut image into a corresponding area of the document information indicating the document.

8. The information processing apparatus according to claim 2, wherein the processor is configured to:
cut an image only for the stamping area stamped by the printer in a case where the document stamped by the printer is read and stamped document information, which indicates the read document, is obtained, and
merge the cut image into a corresponding area of the document information indicating the document.

9. The information processing apparatus according to claim 3, wherein the processor is configured to:
cut an image only for the stamping area stamped by the printer in a case where the document stamped by the printer is read and stamped document information, which indicates the read document, is obtained, and
merge the cut image into a corresponding area of the document information indicating the document.

10. The information processing apparatus according to claim 4, wherein the processor is configured to:
cut an image only for the stamping area stamped by the printer in a case where the document stamped by the printer is read and stamped document information, which indicates the read document, is obtained, and
merge the cut image into a corresponding area of the document information indicating the document.

11. The information processing apparatus according to claim 5, wherein the processor is configured to:
cut an image only for the stamping area stamped by the printer in a case where the document stamped by the printer is read and stamped document information, which indicates the read document, is obtained, and
merge the cut image into a corresponding area of the document information indicating the document.

12. The information processing apparatus according to claim 6, wherein the processor is configured to:
cut an image only for the stamping area stamped by the printer in a case where the document stamped by the printer is read and stamped document information, which indicates the read document, is obtained, and
merge the cut image into a corresponding area of the document information indicating the document.

13. The information processing apparatus according to claim 7, wherein the processor is configured to:
perform control to store information indicating that the stamping area to be merged has been subjected to the stamping work, after performing the merging.

14. The information processing apparatus according to claim 1, wherein the processor is configured to:
notify of instruction information indicating that another person capable of stamping on a corresponding stamping area is instructed to perform the stamping work corresponding to the stamping area, in a case where the stamping work by the printer is stopped or interrupted.

15. The information processing apparatus according to claim 14, wherein the processor is configured to:
notify of the instruction information, in a case where the stamping work by the printer is interrupted and a predetermined period has elapsed.

16. The information processing apparatus according to claim 14, wherein the processor is configured to:
notify of information indicating at least one of a fact that the stamping work on the stamping area is continued or a fact that the other person is not capable of taking over the stamping work, in a case where the stamping work by the printer is stopped or interrupted and there is no other person capable of stamping the corresponding stamping area.

17. The information processing apparatus according to claim 1, wherein the processor is configured to:
present information indicating that the printing has already been performed to the printer, in a case where the printer tries to print the document again and the stamping work is being performed on the document by the printer.

18. The information processing apparatus according to claim 1, wherein the processor is configured to:
notify that stamping on the corresponding stamping area is possible to the person for whom the designation is received.

19. A non-transitory computer readable medium storing an information processing program causing a computer to execute a process comprising:
receiving designation of a person capable of stamping on a plurality of stamping areas in a document having the plurality of stamping areas; and
presenting a stamping area that is capable of being stamped by a printer who performs printing to the printer as a different state from states of other stamping areas in a case where the document is printed and a condition is satisfied, in which the printer is a person capable of stamping on at least one of the plurality of stamping areas and a corresponding stamping area is before a stamping work by another person capable of stamping, and not presenting the stamping area in a case where the condition is not satisfied.

20. An information processing method comprising:
receiving designation of a person capable of stamping on a plurality of stamping areas in a document having the plurality of stamping areas; and
presenting a stamping area that is capable of being stamped by a printer who performs printing to the printer as a different state from states of other stamping areas in a case where the document is printed and a condition is satisfied, in which the printer is a person capable of stamping on at least one of the plurality of stamping areas and a corresponding stamping area is before a stamping work by another person capable of stamping, and not presenting the stamping area in a case where the condition is not satisfied.
